(19) United States
(12) Patent Application Publication
(10) Pub. No.: US 2025/0201495 A1
(43) Pub. Date: Jun. 19, 2025

(54) OPERATING MECHANISM AND ISOLATING SWITCH

(71) Applicant: Chint Low Voltage Electrical Technology Co., Ltd., Songjiang District, Shanghai (CN)

(72) Inventors: Wei YAO, Songjiang District, Shanghai (CN); Denggui AO, Songjiang District, Shanghai (CN); Yongfu XU, Songjiang District, Shanghai (CN); Xinhua GAN, Songjiang District, Shanghai (CN); Dawei YAO, Songjiang District, Shanghai (CN)

(21) Appl. No.: 18/848,831

(22) PCT Filed: May 22, 2023
(86) PCT No.: PCT/CN2023/095425

§ 371 Date: Sep. 19, 2024

(30) Foreign Application Priority Data
May 24, 2022 (CN) 202210568250.X

(51) Int. Cl. H01H 3/38; H01H 9/20

(52) U.S. Cl. CPC H01H 3/38; H01H 9/20

(57) ABSTRACT

Disclosed are an operating mechanism and an isolating switch. The isolating switch includes the operating mechanism. The operating mechanism includes a primary energy storage mechanism and an output shaft, and also a secondary energy storage mechanism. The secondary energy storage mechanism includes a second driving structure and a second energy storage elastic member which are coaxially assembled on the output shaft. The second driving structure includes a fixing member and a locking assembly. The fixing member is provided with two limiting grooves. The primary energy storage mechanism releases energy during an opening process to drive the output shaft to rotate and stores energy for the second energy storage elastic member. After the output shaft drives a locking part of the locking assembly to slide out of one of the limiting grooves and to be unlocked, the second energy storage elastic member releases energy and drives the locking assembly to drive the output shaft to continue rotating to an opening position, and the locking part is driven to slide into the other limiting groove to be locked in a limiting manner. The primary energy storage mechanism and the secondary energy storage mechanism drive the output shaft to rotate twice, such that a contact mechanism can be driven to have a larger opening distance during the opening process, which is conductive to ensuring an electrical performance of the product.

### TECHNICAL FIELD

The present invention relates to the field of low-voltage electrical appliances, and more particularly, to an operating mechanism and an isolating switch.

### BACKGROUND

A switching device is a device which is used to switch a circuit on and off and generally includes an operating mechanism and at least one conductive device. A contact mechanism of each conductive system is driven by the operating mechanism to achieve the purposes of opening and closing. The opening and closing actions of the contact mechanism are completed by the separation or contact of a moving contact and a static contact. A final gap between the moving contact and the static contact when they are disconnected determines an electrical performance of the switching device. In the existing switching device, due to its external dimension, internal structure and other reasons, it is impossible to achieve a large disconnection gap between the moving contact and the static contact, which in turn affects the electrical performance of the product.

### SUMMARY

An object of the present invention is to overcome the defects of the prior art, and to provide an operating mechanism that enables a contact mechanism to have a larger opening distance, and an isolating switch applying the operating mechanism.

In order to achieve the above object, the present invention adopts the following technical solutions:

An operating mechanism, comprising a primary energy storage mechanism and an output shaft, and also a secondary energy storage mechanism, wherein the secondary energy storage mechanism comprises a second driving structure and a second energy storage elastic member which are coaxially assembled on the output shaft; the second driving structure comprises a fixing member and a locking assembly; the fixing member is provided with two limiting grooves; the primary energy storage mechanism releases energy during an opening process to drive the output shaft to rotate and stores energy for the second energy storage elastic member; after the output shaft drives a locking part of the locking assembly to slide out from one of the limiting grooves and to be unlocked, the second energy storage elastic member releases energy and drives the locking assembly to drive the output shaft to continue rotating to an opening position, and the locking part is driven to slide into the other limiting groove to be locked in a limiting manner.

Preferably, the two limiting grooves are a first limiting groove and a second limiting groove, respectively: during an opening process, the locking part first rotates through a preset idle stroke within the first limiting groove along with the output shaft; and after the locking part has no rotational margin within the first limiting groove, the second energy storage elastic member begins to store energy.

Preferably, a central angle of the first limiting groove is greater than a central angle of the second limiting groove, and a central angle of the second limiting groove is equal to a central angle of the locking part: during an opening process, the locking part is unlocked from the first limiting groove first, and then locked with the second limiting groove; and during a closing process, the locking part is unlocked from the second limiting groove first, and then locked with the first limiting groove.

Preferably, the locking assembly comprises a holding member, a sliding member and a locking member; the holding member is fixedly connected to the output shaft, and the sliding member is rotatably assembled on the output shaft and is slidably assembled with the locking member; the locking member is provided with the locking part, and the locking member is rotatable around the output shaft through the sliding member and slidable in a radial direction of the output shaft relative to the sliding member; the second energy storage elastic member is connected between the holding member and the locking member; and the locking part of the locking member is driven to be locked with at least one of the two limiting grooves in a limiting manner.

Preferably, when the locking part is in clamping fit with one of the limiting grooves, the output shaft rotates and drives the second energy storage elastic member to store energy through the holding member; the holding member drives the locking member to slide in a first direction relative to the sliding member, such that the locking part is separated and unlocked from one limiting groove; the unlocked second energy storage elastic member releases energy and drives the holding member to drive the output shaft to continue rotating; and when the locking part rotates to a position corresponding to the other limiting groove, the locking member is driven to slide in a second direction relative to the sliding member and is locked with the other limiting groove in a limiting manner.

Preferably, a first avoidance hole for assembling the output shaft is located in the middle of the fixing member, a central groove for the locking assembly to rotate is located on a surface on one side of the fixing member, and the two limiting grooves are spaced in a circumferential direction of the central groove.

Preferably: a circular shaft hole that is formed in the middle of the sliding member for rotatably connecting to the output shaft, and an edge on one side of the locking member protrudes outward to form the locking part; a first clamping arms are respectively arranged on both sides of the locking member adjacent to the locking part; a second avoidance hole is formed in the middle of the locking member; the locking member slidably sleeves the periphery of the sliding member through the second avoidance hole; a direction of the locking part close to the sliding member is defined as the first direction; and a direction of the locking part away from the sliding member is defined as the second direction; and
a connecting shaft hole that is formed in the middle of the holding member for connection to the output shaft: a second clamping arm which corresponds to the first clamping arms are respectively arranged on both opposite sides of the holding member, and a protrusion that protrudes outward is arranged on the other side of the holding member; the edges on both opposite sides of the protrusion are respectively used as engagement parts for abutting against the corresponding first clamping arms; and the locking member is pushed to be slidably unlocked in the first direction.

Preferably; the second energy storage elastic member comprises a rotating part coaxially assembled with the output shaft; the rotating part is connected to two elastic arms; the first clamping arm and the second clamping arm located on the same side abut against the same elastic arm; when the second energy storage elastic member stores energy, the holding member and the sliding member are misaligned, with one elastic arm abutting against one of the first clamping arms, and the other elastic arm abutting against the second clamping arm on the other side; and
when the locking part moves in the first direction and is separated and unlocked from the limiting groove, the first clamping arm presses against the elastic arm to generate an elastic deformation; and when the second elastic energy storage member releases energy to drive the locking member to rotate, the elastic arm releases energy to push the first clamping arm, such that the locking part is locked with the other limiting groove in the second direction in a limiting manner.

Preferably, the primary energy storage mechanism comprises a first driving structure and at least one first energy storage elastic member; the first driving structure comprises an operating shaft and a rotating member that are connected in linkage sequentially, wherein the rotating member is in linkage fit with the output shaft; the first energy storage elastic member is engaged with the rotating member; the operating shaft drives the rotating member to rotate, such that the first energy storage elastic member rotates to a balanced position to store energy; and the first energy storage elastic member releases energy after crossing the balanced position and drives the rotating member to rotate, such that the rotating member drives the output shaft to rotate.

Preferably, during an opening process, the first energy storage elastic member releases energy and drives the output shaft to rotate from a closing position to a first critical position through the rotating member; and the output shaft rotates and drives the second energy storage elastic member to release energy after energy storage, driving the output shaft to continue rotating to an opening position.

Preferably, in a closing process, the first energy storage elastic member releases energy and drives the output shaft to rotate to a closing position through the rotating member.

Preferably, the first driving structure further comprises an operating shaft, a transmission assembly and a rotating member; the operating shaft drives the rotating member to rotate through the transmission assembly, and the transmission assembly and the rotating member are in linkage with the output shaft respectively: during an opening process, the operating shaft drives the rotating member to rotate through the transmission assembly, the rotating member rotates and drives the first energy storage elastic member to release energy after crossing a balanced position, the first energy storage elastic member releases energy and drives the output shaft to rotate to the first critical position through the rotating member, and the output shaft rotates and drives the second energy storage elastic member to release energy after energy storage, driving the output shaft to continue rotating to an opening position; and during a closing process, the operating shaft drives the rotating member to rotate through the transmission assembly, such that the first energy storage elastic member rotates to the balanced position to store energy and to release energy after crossing the balanced position, and meanwhile, the transmission assembly also drives the output shaft to rotate, such that the second energy storage elastic member releases energy after energy storage, and the first energy storage elastic member releases energy and drives the output shaft to rotate to a closing position through the rotating member.

Preferably, the transmission assembly comprises a transmission shaft and a transmission plate; the transmission shaft is rotatably arranged; the transmission plate is arranged in linear motion; the operating shaft drives the rotating member to rotate through the transmission shaft; the operating shaft drives the transmission plate to move linearly between a transmission plate opening position and a transmission plate closing position; and during a closing process, the operating shaft drives the transmission plate to move towards the transmission plate closing position, and drives the output shaft to rotate through the transmission plate.

Preferably, the transmission shaft comprises a first transmission shaft and a second transmission shaft; the first transmission shaft is fixedly connected to or in transmission fit with the second transmission shaft; the first transmission shaft is in linkage with the operating shaft and the transmission plate respectively; the second transmission shaft is in linkage with the rotating member; the transmission plate and the rotating member are in linkage fit with the output shaft respectively.

Preferably, the operating shaft is provided with a first gear surrounding a side wall: a gear part that is in meshed connection with the first gear is arranged on one side of the first transmission shaft facing the operating shaft: a second gear surrounding the side wall of the first transmission shaft is arranged in the middle of the first transmission shaft; the second gear is in meshed connection with teeth of the transmission plate; and the transmission plate is provided with a first shifting rod, and the second transmission shaft is provided with a third shifting rod which is used for driving the rotating member to rotate.

Preferably, a side wall of the output shaft is provided with a protruding first stopper and a second shifting rod, and the first stopper is engaged with the first shifting rod of the transmission plate.

Preferably, one end of the rotating member is rotatably installed: spring clamping grooves are formed on both opposite sides of the rotating member respectively: a second stopper, a third stopper block and a fourth stopper are spaced annularly in sequence at the other end of the rotating member in a protruding manner; the second stopper and the third stopper are used for abutting against the third shifting rod; and the third stopper and the fourth stopper are used for abutting against the second shifting rod.

Preferably; the output shaft includes a first output shaft and a second output shaft, wherein one end of the first output shaft is in pluggable fit with one end of the second output shaft, and the other end of the first output shaft and the other end of the second output shaft are respectively used for linkage connection with the contact mechanism, the first output shaft is driven by a primary energy storage mechanism, and the second output shaft is driven by a secondary energy storage mechanism.

Preferably, a central axis of the rotating member of the first driving structure is perpendicular to an axis of the output shaft.

The present invention further provides an isolating switch, comprising a shell within which at least one conductive system and any one of the aforementioned operating mechanisms are assembled. The contact mechanism of the conductive system is connected in linkage with an output shaft of the operating mechanism.

According to an operating mechanism and an isolating switch of the present invention, a primary energy storage mechanism of the operating mechanism releases energy to drive an output shaft to rotate and stores energy for a secondary energy storage mechanism, and the unlocked secondary energy storage mechanism releases energy, enabling the output shaft to continue rotating to an opening position. The two driving rotations of the output shaft can drive a contact mechanism to achieve a greater opening distance during an opening process, which is conducive to ensuring an electrical performance of the product.

In addition, at the beginning of the opening process, a locking part rotates at a preset idle stroke in a first limiting groove first along with the output shaft. After the locking part has no rotational margin within the first limiting groove, a second energy storage elastic member begins to store energy. Due to the existence of the rotational margin, there is no need to overcome an elastic force of the second energy storage elastic member in the secondary energy storage mechanism at the beginning of the opening process, thereby promoting a breaking performance.

In addition, the motion states during the opening and closing processes are not symmetrical. During the closing process, in order to ensure a closing speed, a driving force is primarily provided by the energy release of the first energy storage mechanism. However, in the last stage of the opening process, the first energy storage mechanism has completed the energy release, while the second energy storage mechanism has not completed the energy release, or the second energy storage mechanism has completed the energy release alone. This design ensures both the closing speed during the closing process and the opening distance during the opening process.

### BRIEF DESCRIPTION OF THE DRAWINGS

FIG. 1 is a schematic structural diagram of an operating mechanism in the present invention;

FIG. 2 is a schematic structural diagram of a primary energy storage mechanism during a closing process in the present invention;

FIG. 3 is a schematic structural diagram of the primary energy storage mechanism during an opening process in the present invention;

FIG. 4 is a schematic structural diagram when a first energy storage elastic member is located in a first energy release position in the present invention;

FIG. 5 is a schematic structural diagram when the first energy storage elastic member is located in a second energy release position in the present invention;

FIG. 6 is a schematic structural diagram of an operating shaft in the present invention;

FIG. 7 is a schematic structural diagram of a first transmission shaft in the present invention;

FIG. 8 is a schematic structural diagram of a transmission plate in the present invention;

FIG. 9 is a schematic structural diagram of a second transmission shaft in the present invention;

FIG. 10 is a schematic structural diagram of a rotating member in the present invention;

FIG. 11 is a schematic structural diagram of the first energy storage elastic member in the present invention;

FIG. 12 is a schematic structural diagram of a secondary energy storage mechanism during a closing process in the present invention;

FIG. 13 is a schematic structural diagram of the secondary energy storage mechanism during an opening process in the present invention;

FIG. 14 is a schematic structural diagram when a locking part and a first limiting groove are engaged in a first critical position in the present invention;

FIG. 15 is a schematic structural diagram when the locking part and a second limiting groove are engaged in a second critical position in the present invention;

FIG. 16 is a schematic structural diagram of a fixing member in the present invention;

FIG. 17 is a schematic structural diagram when the locking member and a sliding member are engaged in the present invention;

FIG. 18 is a schematic structural diagram of a holding member in the present invention;

FIGS. 19-20 are schematic structural diagrams of a first output shaft in the present invention; and

FIGS. 21-22 are schematic structural diagrams of a second output shaft in the present invention.

### DETAILED DESCRIPTION OF THE INVENTION

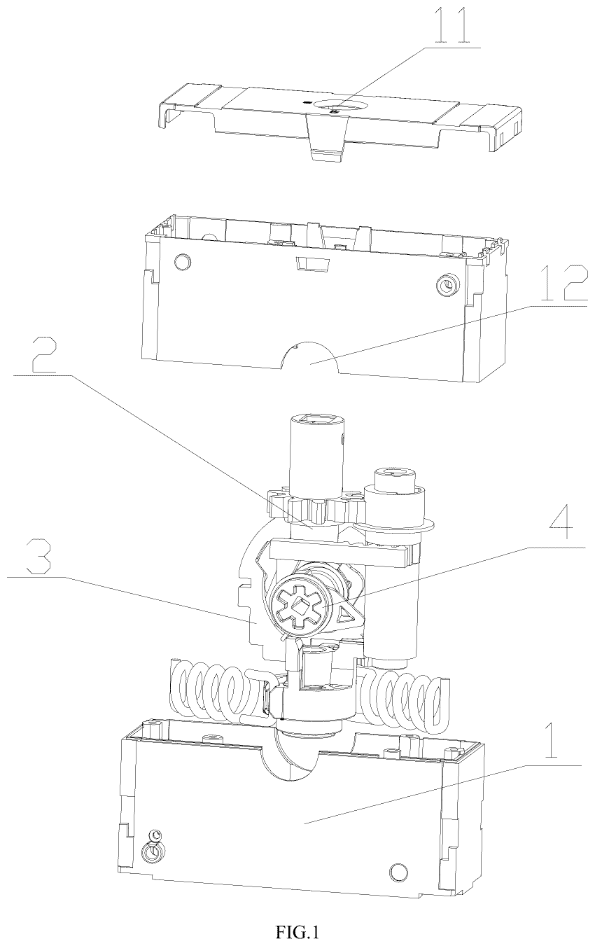

The specific implementations of an operating mechanism and an isolating switch of the present invention will be further described below with reference to the embodiments given in FIGS. 1 to 22. An operating mechanism and an isolating switch of the present invention are not limited to the description of the following embodiments.

An isolating switch includes a shell in which an operating mechanism and at least one conductive system are assembled. Each conductive system includes a contact mechanism in linkage with the operating mechanism. The contact mechanism includes a moving contact and a static contact that are engaged with each other. The moving contact is connected in linkage with the operating mechanism, such that the moving contact is in contact with or separated from the static contact under the driving force of the operating mechanism, and the conductive system is switched on or off. The existing operating mechanism includes a primary energy storage mechanism 2. In opening and closing processes, the primary energy storage mechanism 2 rotates to store energy; and after crossing a dead center, the primary energy storage mechanism 2 releases energy to drive an output shaft 4 to quickly rotate to an opening position or a closing position.

The present application has the following improvement point; the operating mechanism includes a primary energy storage mechanism 2, a secondary energy storage mechanism 3 and an output shaft 4, wherein the primary energy storage mechanism 2 and the secondary energy storage mechanism 3 are connected in linkage with the output shaft 4, respectively. During the opening process, after the energy storage of the primary energy storage mechanism 2 is completed, the primary energy storage mechanism 2 releases energy to drive the output shaft 4 to rotate and stores energy for the secondary energy storage mechanism 3. After the output shaft 4 is opened and rotates to drive the secondary energy storage mechanism to be unlocked, the unlocked secondary energy storage mechanism 3 releases energy, and the output shaft 4 continues rotating until the secondary energy storage mechanism 3 is locked again. According to the present application, with the secondary energy storage mechanism 3, the output shaft 4 is driven by the primary energy storage mechanism 2 and the secondary energy storage mechanism 3 twice to rotate during the opening process, such that the contact mechanism may be driven to have a larger opening distance, which is conducive to ensuring an electrical performance of the product.

In conjunction with FIGS. 1-22, a specific embodiment of an operating mechanism is provided, and its specific structure is not limited to this embodiment.

As shown in FIG. 1, the operating mechanism includes a housing 1 in which a primary energy storage mechanism 2, a secondary energy storage mechanism 3 and an output shaft 4 are assembled.

As shown in FIGS. 1-3, the primary energy storage mechanism 2 includes a first driving structure and at least one first energy storage elastic member 26. In this embodiment, the first driving structure includes an operating shaft 21 and a rotating member 25 that are connected in linkage sequentially wherein the rotating member 25 is in linkage fit with the output shaft 4. A pair of first energy storage elastic members 26 are connected to both opposite sides of the rotating member 25 respectively and used for being engaged with the rotating member 25. The operating shaft 21 drives the rotating member 25 to rotate, such that the first energy storage elastic members 26 rotate to a balanced position to store energy. The first energy storage elastic members 26 release energy after crossing the balanced position and drive the rotating member 25 to rotate, such that the rotating member 25 drives the output shaft 4 to rotate. The first driving structure of the primary energy storage mechanism 2 is arranged in a vertical direction of the housing 1. The pair of first energy storage elastic members 26 are engaged on the left and right sides of the first driving structure and are respectively connected to an inner side wall of the housing 1. An operating hole 11 is formed in an upper side wall of the housing 1. The operating shaft 21 of the primary energy storage mechanism 2 is driven by a handle or other tools, and the operating shaft 21 drives the rotating member 25 to rotate through the transmission assembly, so that the primary energy storage mechanism 2 stores and releases energy, thereby driving the output shaft 4 which is arranged perpendicular to a front-to-rear direction of the housing 1 to rotate. A linkage hole 12 is respectively formed in front and rear side walls of the housing 1. The contact mechanism of the conductive system is connected in linkage with the end of the output shaft 4 through the linkage holes 12. When the output shaft 4 rotates to the closing position or the opening position, the contact mechanism is driven to close or open, which is the prior art in the field.

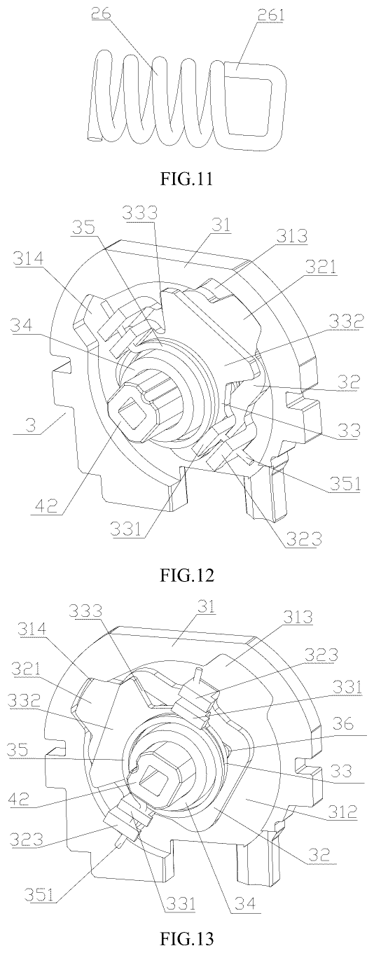

Preferably, the operating mechanism is also provided with a secondary energy storage mechanism 3. The secondary energy storage mechanism 3 in this embodiment includes a second driving structure and a second energy storage elastic member 35. In FIG. 1, a central axis of the first driving structure is perpendicular to a central axis of the second driving structure. As shown in FIGS. 12-15, the second driving structure includes a fixing member 31 and a locking assembly. The second driving structure and the second energy storage elastic member 35 are coaxially assembled on the output shaft 4. The fixing member 31 is fixedly assembled, and provided with two limiting grooves, which are a first limiting groove 313 and a second limiting groove 314 respectively. The fixing member 31 may be a housing 1 or a component that is fixedly assembled on the output shaft 4 alone. Preferably, the fixing member 31 is a component that is assembled on the output shaft 4 alone. The locking assembly includes a locking part 321 that is in a limiting fit with the limiting groove, and the second energy storage elastic member 35 acts on the locking assembly, such that the locking part 321 is in locking fit with the limiting groove of the fixing member 31. The primary energy storage mechanism 2 drives the output shaft 4 to rotate, and can store energy for the second energy storage elastic member 35. After the output shaft 4 drives the locking part 321 of the locking assembly to slide out of one of the limiting grooves and to be unlocked, the second energy storage elastic member 35 releases energy and drives the locking assembly to drive the output shaft 4 to continue rotating until the locking part 321 is driven to slide into the other limiting groove to be locked in a limiting manner.

In this embodiment, when the operating mechanism is opened, the primary energy storage mechanism 2 rotates to store energy, and then the primary energy storage mechanism 2 releases energy to drive the output shaft 4 to rotate in an opening direction, in order to store energy for the second energy storage elastic member 35. After the output shaft 4 drives the locking part 321 of the locking assembly to slide out of one of the limiting grooves in a first direction and to be unlocked, the second energy storage elastic member 35 releases energy and drives the locking assembly to drive the output shaft 4 to continue rotating to an opening position, till the locking part 321 is driven to slide into the other limiting groove in a second direction and to be locked in a limiting manner. Specifically, the primary energy storage mechanism 2 rotates to store energy, and then the primary energy storage mechanism 2 releases energy to drive the output shaft 4 to rotate from the closing position to the opening position. The output shaft 4 rotates to drive the locking assembly of the second driving structure and to store energy for the second energy storage elastic member 35. When the primary energy storage mechanism 2 releases energy and drives the output shaft 4 to rotate to a first critical position, the output shaft 4 drives the locking part 321 of the locking assembly to slide out of one of the limiting grooves in the first direction and to be unlocked. The second energy storage elastic member 35 releases its stored energy, actuating the locking assembly to drive the output shaft 4 into continued rotation. During this phase, the primary driving force for the continued rotation of the output shaft 4 originates from the secondary energy storage mechanism 3. This rotation persists until the output shaft 4 reaches the open position, at which point the locking part 321 is actuated to slide into another limiting groove along the second direction, becoming securely locked in place. Consequently, the secondary energy storage mechanism 3 is relocked. In this embodiment, with the secondary energy storage mechanism 3, the output shaft is driven by the primary energy storage mechanism 2 to rotate to the first critical position during the opening process, and the secondary energy storage mechanism 3 stores energy first and is then unlocked to release energy. The output shaft is driven to continue rotating from the first critical position to the opening position. By driving the rotation twice, the contact mechanism may be driven to have a larger opening distance when during the opening process, which is conducive to ensuring the electrical performance of the product. The first critical position is a position where the locking part 321 of the secondary energy storage mechanism 3 slides out of one of the limiting grooves and to be unlocked and begins to release energy. i.e., an intermediate position where the output shaft 4 rotates from the closing position to the opening position. When the output shaft 4 is in the closing position, the locking part 321 is in locking fit with this this limiting groove. When the output shaft 4 rotates to the first critical position, the locking part 321 slides out of one of the limiting grooves and to be unlocked and begins to release energy. When the output shaft 4 rotates to the opening position, the locking part 321 is in locking fit with the other limiting groove. In this embodiment, the output shaft 4 is driven by the energy release of the first energy storage elastic member 26 from the closing position to the first critical position, and then primarily driven by the energy release of the second energy storage elastic member 35 from the first critical position to the opening position. Of course, when the second energy storage elastic member 35 initially releases energy, the first energy storage elastic member 26 may also provide a driving force for the continuous rotation of the output shaft 4, which is permissible and falls within the scope of protection of this application.

When the operating mechanism is closed, an embodiment is a technical solution similar to an opening process. That is, the primary energy storage mechanism 2 rotates to store energy, and then the primary energy storage mechanism 2 releases energy to drive the output shaft 4 to rotate from the opening position to the closing position. The output shaft 4 rotates to drive the locking assembly of the second driving structure and to store energy for the second energy storage elastic member 35. When the output shaft 4 rotates to a second critical position, the locking part 321 of the locking assembly is driven to slide out of the other limiting groove in the first direction and to be unlocked. The second energy storage elastic member 35 releases energy and drives the locking assembly to drive the output shaft 4 to continue rotating, till the output shaft 4 rotates to the opening position, and the locking part 321 is driven to slide into one limiting groove in the second direction and to be locked in a limiting manner. The secondary energy storage mechanism 3 is relocked. However, with this scheme, the output shaft 4 is mainly provided with a driving force by the secondary energy storage mechanism 3 from the second critical position to the closing position, so a closing speed during the closing process is hardly ensured. The second critical position is a position where the locking part 321 of the secondary energy storage mechanism 3 slides out of the other limiting groove and begins to release energy, i.e., an intermediate position where the output shaft 4 rotates from the opening position to the closing position. It should be noted that the first critical position and the second critical position may be the same position or may not be the same position.

Particularly: as shown in FIGS. 1-3, a preferred embodiment of the present application is shown. The primary energy storage mechanism 2 includes a first driving structure and at least one second energy storage elastic member 26. The first driving structure further includes a transmission assembly: that is, the first driving structure includes an operating shaft 21, a transmission assembly and a rotating member 25 that are connected in linkage sequentially, and the transmission assembly and the rotating member 25 are connected in linkage with the output shaft 4 respectively. The first energy storage elastic member 26 is engaged with the rotating member 25. The rotating member 25 rotates and drives the first energy storage elastic member 26 to rotate to the balanced position to store energy; and after crossing the balanced position, releases energy to drive the rotating member 25 to rotate. The operating shaft 21 drives the rotating member 25 through the transmission assembly, such that the first energy storage elastic member 26 stores and releases energy to drive the output shaft 4 to rotate, and can also directly drive the output shaft 4 to rotate through the transmission assembly. During the opening process, the operating shaft 21 drives the rotating member 25 to rotate through the transmission assembly. During the opening process, the transmission assembly does not drive the output shaft 4. The rotating member 25 rotates and drives the first energy storage elastic member 26 to release energy after crossing the balanced position, that is, after crossing a dead center. The first energy storage elastic member 26 releases energy to drive the rotating member 25 to rotate rapidly; the rotating member 25 drives the output shaft 4 to rotate, and the output shaft 4 rotates to drive the locking assembly of the second driving structure and stores energy for the second energy storage elastic member 35. When the output shaft 4 rotates to the first critical position, the output shaft 4 rotates to drive the locking part 321 of the locking assembly to slide out of the first limiting groove 313 and to be unlocked. The second energy storage elastic member 35 releases energy and drives the locking assembly to drive the output shaft 4 to continue rotating to the opening position, and the locking part 321 is driven to slide into the second limiting groove 314 and to be relocked. The opening process is similar to the foregoing process.

The difference lies during the closing process. During the closing process, the operating shaft 21 drives the rotating member 25 to rotate through the transmission assembly, and meanwhile the transmission assembly also drives the output shaft 4 to rotate. That is, as the rotating member 25 rotates, it simultaneously energizes the first energy storage elastic element 26, while the rotation of the output shaft 4 drives the locking assembly, enabling the second energy storage elastic element 35 to store energy and then release it. When the output shaft 4 rotates to the second critical position, the output shaft 4 rotates to drive the locking part 321 of the locking assembly to slide out of the second limiting groove 314 and to be unlocked for energy release, and the second energy storage elastic member 35 releases energy to drive the locking assembly to drive the output shaft 34 to continue rotating to the closing position, till the locking part 321 is driven to slide into the first limiting groove 313 and to be locked again. Meanwhile, the rotating member 25 rotates and drives the first energy storage elastic member 26 to release energy after crossing the balanced position, that is, after crossing the dead center, the first energy storage elastic member 26 releases energy to drive the rotating member 25 to rotate rapidly, and the first energy storage elastic member 26 releases energy and drives the output shaft 4 to rotate to the closing position through the rotating member 25. That is, during the closing process, after the second energy storage elastic member 35 crosses the dead center and releases energy, it continuously drives the output shaft 4 to rotate to the closing position. The primary driving force for rotating the output shaft 4 to the closing position is provided by the first energy storage elastic element 26, ensuring the closing speed.

Preferably, in the final stage of closing, the output shaft 4 may also be jointly driven by the first energy storage elastic member 26 and the second energy storage elastic member 3 to rotate to the closing position. That is, after the output shaft 4 rotates over the second critical position to unlock the second driving structure and the rotating member 25 rotates to drive the first energy storage elastic member 26 to cross the balanced position, the first energy storage elastic member 26 and the second energy storage elastic member 35 jointly drive the output shaft 4 to rotate to the closing position. Of course, the output shaft 4 may also be driven to the closing position only by the first energy storage elastic member 26. Throughout the entire closing process, the primary energy storage mechanism 2 releases energy to provide the primary driving force for the rotation of the output shaft 4. Additionally, the secondary energy storage mechanism 3 can also contribute partially to the driving force for the rotation of the output shaft 4, but it is not mandatory: it can choose not to release energy depending on actual needs. The decision to release energy from the secondary energy storage mechanism 3 is adjustable based on specific requirements. In addition, during the closing process, whether the transmission assembly first drives the output shaft 4 to rotate to the second critical position, or first drives the rotating member 25 to rotate to make the first energy storage elastic member 26 cross the balanced position may be adjusted accordingly as needed, as long as the primary driving force is provided by the first energy storage elastic member 26, and the first energy storage elastic member 26 continuously drives the output shaft 4 to rotate to the closing position after crossing the balanced position, all of which belong to the protection scope of the present application. The second critical position is a position where the locking part 321 of the secondary energy storage mechanism 3 slides out of the other limiting groove and to be unlocked and begins to release energy, i.e., an intermediate position where the output shaft 4 rotates from the closing position to the opening position. When the output shaft 4 is in the opening position, the locking part 321 is in locking fit with the other limiting groove. When the output shaft 4 rotates to the second critical position, the locking part 321 slides out of the other limiting groove and to unlock and begin releasing energy. When the output shaft 4 rotates to the closing position, the locking part 321 is in locking fit with one limiting groove. In this embodiment, the output shaft 4 is driven by the transmission assembly from the opening position to the second critical position, and/or the first energy storage elastic element 26 releases energy to drive the output shaft 4 after being initially driven by the transmission assembly. After the first energy storage elastic element 26 releases energy, it drives the output shaft 4 to rotate until it reaches the closing position.

In this embodiment, motion states in the opening and closing processes of the operating mechanism are not symmetrical. During the closing process, in order to ensure a closing speed, a driving force is primary provided by the energy release of the first energy storage mechanism. However, in the last stage of the opening process, the first energy storage mechanism has already completed the energy release, while the second energy storage mechanism has not. The second energy storage mechanism completes the opening process solely through its own energy release. This arrangement ensures both the closing speed during closing and the opening distance during opening, and represents an embodiment of the present invention.

Preferably, the two limiting grooves are a first limiting groove 313 and a second limiting groove 314 respectively, a central angle of the first limiting groove 313 is greater than a central angle of the second limiting groove 314, and the central angle of the second limiting groove 314 is equal to a central angle of the locking part 321, such that the locking part 321 has a certain rotational margin when it is engaged with the first limiting groove 313, and the locking part 321 has no rotational margin when it is engaged with the second limiting groove 314. During the opening process, the locking part 321 first rotates at a preset idle stroke in the first limiting groove 313 along with the output shaft 4, and after the locking part 321 has no rotational margin with the first limiting groove 313, the second energy storage elastic member 35 begins to store energy when the locking part 321 is in clamping fit with the first limiting groove 313. In this way, in the initial stage of opening, due to the existence of the preset idle stroke. i.e., the existence of the rotational margin, it is not necessary to overcome an elastic force of the second energy storage elastic member 35 in the secondary energy storage mechanism 3, thereby promoting the breaking performance.

A specific opening process is as follows: during the energy release of the primary energy storage mechanism 2 such that the output shaft 4 rotates to the first critical position, the locking part 321 first rotates at the preset idle stroke in the first limiting groove 313 along with the output shaft 4, and the second energy storage elastic member 35 does not store energy at this stage: after the locking part 321 has no rotational margin with the first limiting groove 313, that is, under the clamping fit of the locking part 321 and the first limiting groove 313, the second energy storage elastic member 35 begins to store energy; when the output shaft 4 rotates to the first critical position, the locking part 321 is driven to slide in the first direction, such that the locking part 321 is separated and unlocked from the first limiting groove 313, and the energy storage of the second energy storage elastic member 35 has been completed. The second energy storage elastic member 35 releases energy to drive the locking part 321 to rotate, and meanwhile drive the output shaft 4 to continue rotating until the locking part 321 is driven to slide into the second limiting groove 314 in the second direction and to be locked in a limiting manner, thereby completing the opening process. During the closing process, i.e., in the process of the driving shaft 4 rotating from the opening position to the second critical position, because the locking part 321 has no rotational margin when it is engaged with the second limiting groove 314, the second energy storage elastic member 35 stores energy synchronously until the locking part 321 is separated and unlocked from the second limiting groove 314, and the second energy storage elastic member 35 begins to release energy and drives the output shaft 4 to continue rotating. In the process that the output shaft 4 rotates to the locking part 321 and has no rotational margin with the first limiting groove 313, due to the existence of the rotational margin, it is unnecessary to overcome an elastic force of the second energy storage elastic member in the secondary energy storage mechanism 3, thereby promoting the breaking performance.

In conjunction with drawings, a specific structure of a preferred embodiment of the operating mechanism is further described. The operating mechanism is not limited to this embodiment.

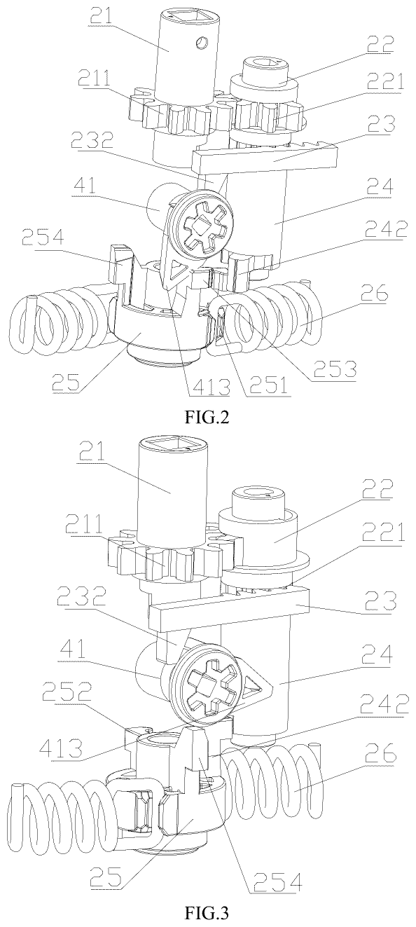

As shown in FIGS. 2-3, the primary energy storage mechanism 2 includes a first driving structure and a pair of first energy storage elastic members 26. The first driving structure includes an operating shaft 21, a transmission assembly and a rotating member 25 that are connected in linkage sequentially. The transmission assembly and the rotating member 25 are connected in linkage with the output shaft 4, respectively. In this embodiment, the transmission assembly includes a transmission shaft and a transmission plate 23. The transmission shaft is arranged rotatably. The transmission plate 23 is arranged in linear motion. The operating shaft 21 drives the rotating member 25 to rotate through the transmission shaft. The operating shaft 21 drives the transmission plate 23 to move linearly between a transmission plate opening position and a transmission plate closing position. During the opening process, the operating shaft 21 drives the transmission plate 23 to move to the transmission plate 23 opening position, but the transmission plate 23 does not drive the output shaft 4 to rotate. During the closing process, the operating shaft 21 drives the transmission plate 23 to move to the transmission plate closing position, and the transmission plate 23 drives the output shaft 4 to rotate. The operating shaft 21 may directly drive the transmission plate 23 to move, and may also indirectly drive the transmission plate 23. In this embodiment, the transmission plate 23 is driven by the rotation of the transmission shaft, that is, the transmission shaft drives the rotating member 25 to rotate and also drives the transmission plate 23 to move.

The transmission shaft includes a first transmission shaft 22 and a second transmission shaft 24, which are split. The first transmission shaft 22 is fixedly connected to or has a transmission fit with one end of the second transmission shaft 24. The first transmission shaft 22 is connected in linkage with the operating shaft 21 and the transmission plate 23 respectively, the second transmission shaft 24 is connected in linkage with the rotating member 25. Both the transmission plate 23 and the rotating member 25 are respectively in linkage with the output shaft 4.

During the opening process, the operating shaft 21 drives the first transmission shaft 22 to rotate, the first transmission shaft 22 drives the transmission plate 23 to move horizontally to the transmission plate opening position, and the rotating member 25 is driven by the second transmission shaft 24 to rotate, such that the first energy storage elastic member 26 stores energy. The first energy storage elastic member 26 releases energy after crossing the balanced position. The output shaft 4 is driven by the rotating member 25 to rotate from the closing position to the first critical position, and this action first allows the second energy storage elastic member 35 to complete energy storage before releasing it, driving the output shaft 4 to rotate to the opening position. Preferably, when the output shaft 4 rotates to the opening position, the output shaft 4 and the transmission plate 23 are limited in position.

During the closing process, the operating shaft 21 drives the first transmission shaft 22 to rotate, which in turn drives the transmission plate 23 to move horizontally to the closing position. The transmission plate 23 drives the output shaft 4 to rotate from the opening position to the second critical position, and the first transmission shaft 22 rotates and drives the rotating member 25 to rotate via the second transmission shaft 24. The output shaft 4 rotates to drive the second energy storage elastic member 35 to store energy: The rotating member 25 rotates and drives the first energy storage elastic member 26 to store energy, and the first energy storage elastic member 26 crosses the balanced position to release energy. The first energy storage elastic member 26 releases energy and drives the rotating member 25 to continue rotating, and the rotating member 25 rotates to drive the output shaft 4 to continue rotating. After the output shaft 4 crosses the second critical position, the second energy storage elastic member 35 completes energy storage and releases energy. The release of energy from both the first energy storage elastic member 26 and the second energy storage elastic member 35 drives the output shaft 4 to rotate to the closing position.

As shown in FIGS. 2, 3 and 6, the operating shaft 21 is arranged along the a vertical direction of the housing 1. A groove structure is formed in an upper end surface of the operating shaft 21, which is opposite to an operating hole 11 of the housing 1, for driving the rotation of the operating shaft 21 by using a handle or other tools. A first gear 211 is arranged around a middle side wall of the operating shaft 21.

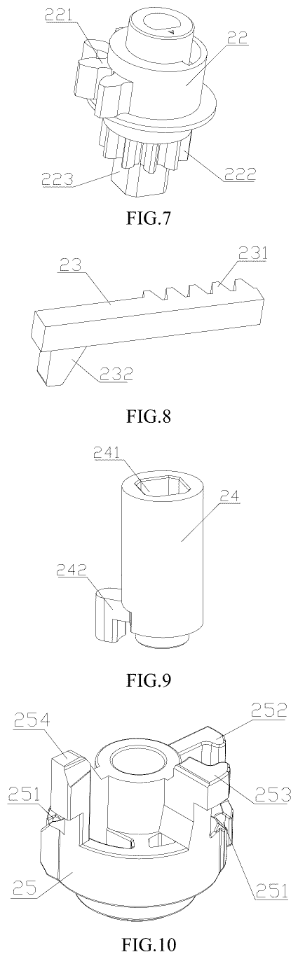

As shown in FIGS. 2, 3, and 7-9, the first transmission shaft 22 is arranged vertically along the housing 1 on one side of the operating shaft 21. A fan-shaped gear part 221 is arranged on one side of the first transmission shaft 22 facing the operating shaft 21. The fan-shaped gear part 221 is in meshed connection with the first gear 211 of the operating shaft 21, and a second gear 222 is arranged around the middle side wall of the first transmission shaft 22. That is, the second gear 222 is located at the lower side of the gear part 221, and the first transmission shaft 22 is in pluggable fit with one end of the second transmission shaft 24. In FIG. 7, a square convex column 223 is formed at the lower end of the first transmission shaft 22, a square groove 241 that is in pluggable fit with the square convex column 223 is formed in the upper end of the second transmission shaft 24, and a third shifting rod 242 is arranged at the other end of the second transmission shaft 24. That is, the third shifting rod 242 is arranged at the lower end of the second transmission shaft 24, and the third shifting rod 242 extends downward. The transmission plate 23 is arranged to move in a direction perpendicular to the first transmission shaft 22, and a plurality of teeth 231 for meshed connection with the second gear 222 is arranged on one side of the transmission plate 23 facing the first transmission shaft 22, such that the transmission plate 23 is engaged with the second gear 222 through the teeth 231 to perform a linear reciprocating motion. A first shifting rod 232 that is engaged with the output shaft 4 is arranged at one end of the transmission plate 23. In FIG. 8, the first shifting rod 232 is directed downwards, and an orientation of the first shifting rod 232 is appropriately changed when the output shaft 4 is located in other directions. Of course, the transmission shaft may also adopt an integrated structure. In this way; the transmission shaft is connected in linkage with the operating shaft 21, the transmission plate 23 and the rotating member 25 respectively, and the rotating member 25 and the transmission plate 23 are in linkage with the output shaft 4 respectively to drive the output shaft 4 to rotate. In addition, as other embodiments, the first transmission shaft 22 and the second transmission shaft 24 may also be of split structures, and rotational axes of the first transmission shaft 22 and the second transmission shaft 24 are spaced in parallel. That is, one end of the first transmission shaft 22 is in transmission fit with the operating shaft 21, and the other end of the first transmission shaft 22 is in transmission fit with the second transmission shaft 24. That is, the operating shaft 21 rotates to drive the first transmission shaft 22 to rotate, and the first transmission shaft 22 synchronously drives the second transmission shaft 24 to rotate. The first transmission shaft 22 and the transmission plate 23 are connected through meshing transmission, which can accurately control the position and distance of transmission, and the fan shaped gear part 221 can adjust the angle at which the transmission plate 23 drives the output shaft 4 to rotate during the closing process. Of course, the first transmission shaft 22 and the transmission plate 23 may also be connected through other transmission modes.

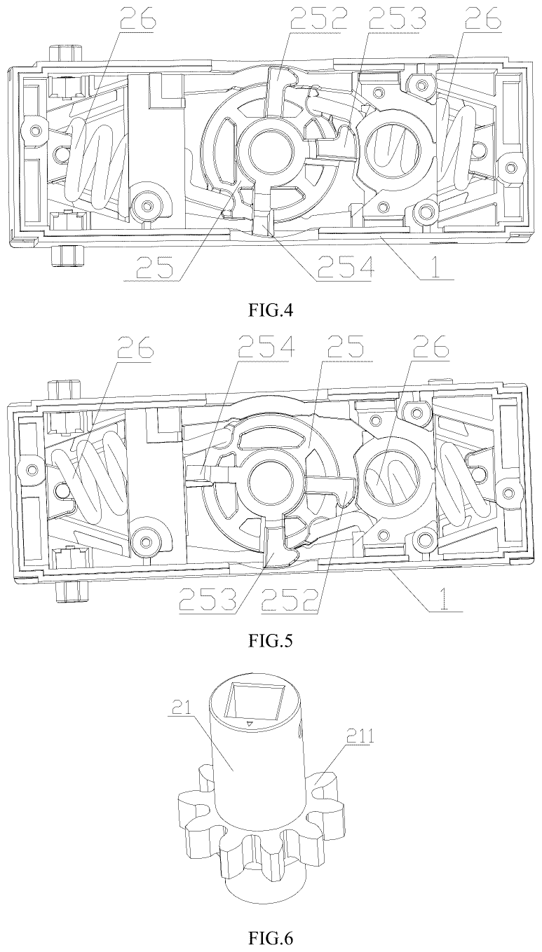

As shown in FIGS. 2-5, and 10, the rotating member 25 is arranged at the lower part of the housing 1, and is rotatably connected to the housing 1 at the lower end of the rotating member 25. Spring clamping grooves 251 are respectively provided on both opposite sides of the rotating member 25. One end of each first energy storage elastic member 26 is connected to the rotating member 25 through the spring clamping groove 251, and the other end is connected to a side wall of the housing 1. In FIGS. 2-5, and 11, the first energy storage elastic member 26 is a spring, wherein one end of the first energy storage elastic member 26 is rotatably connected to the housing 1, and a closed annular connecting part 261 is formed at the other end of the first energy storage elastic member 26 and used for being clamped with the spring clamping groove 251. In an initial state, an axis of the rotating member 25 is eccentric to an axis of the first energy storage elastic member 26. The rotating member 25 rotates and drives the spring clamping groove 251 to rotate, such that the first energy storage elastic member 26 also rotates synchronously. The rotating member 25 drives the first energy storage elastic member 26 to store energy in the early stage of rotation. When the rotating member 25 rotates and allows the axis of the first energy storage elastic member 26 and the axis of the rotating member 25 to be located on a straight line, they are located on the balanced position, i.e., on the dead center position. At this moment, the first energy storage elastic member 26 is compressed to its shortest length. After the rotating member 25 drives the first energy storage elastic member 26 to rotate over the balanced position, the first energy storage elastic member 26 releases energy and drives the rotating member 25 to rotate rapidly, so as to drive the output shaft 4 to rotate. A second stopper 252, a third stopper 253 and a fourth stopper 254 are spaced annularly in sequence at the other end of the rotating member 25 in a protruding manner, wherein the second stopper 252 and the third stopper 253 are located on both sides of one spring clamping groove 251 respectively, and the fourth stopper 254 is located in a position close to the other spring clamping groove 251. In FIGS. 2-5 and 10, the second stopper 252 and the fourth stopper 254 are arranged along the same diameter of the rotating member 25, and the third stopper 253 is located between the second stopper 252 and the fourth stopper 254. In FIGS. 4 and 5, an included angle between the third stopper 253 and the second stopper 252 is approximately 90 degrees. In this embodiment, a protruding height of the fourth stopper 254 is greater than that of the second stopper 252 and the third stopper 253, and a protruding height of the second stopper 252 is the same as that of the third stopper 253. The second stopper 252 and the third stopper 253 are used to abut against the third shifting rod 242 of the second transmission shaft 24, and the third stopper 253 and the fourth stopper 254 are used to be engaged with the second shifting rod 413 arranged on the output shaft 4.

Preferably, in this embodiment, the output shaft 4 includes a first output shaft 41 and a second output shaft 42 as shown in FIGS. 19-22, wherein one end of the first output shaft 41 is in pluggable fit with one end of the second output shaft 42, and the other end of the first output shaft 41 and the other end of the second output shaft 42 are respectively used for connection in linkage with the contact mechanism located on one side of the housing 1. The first output shaft 41 is used for being in driving fit with the first driving structure, and the second output shaft 42 is in driving fit with the second driving structure and the second energy storage elastic member 35. Of course, the first output shaft 41 and the second output shaft 42 may also be of an integrated structure. The first driving structure and the second driving structure are respectively in driving connection with different areas of the output shaft 4. Preferably, a central axis of the first driving structure is perpendicular to that of the second driving structure, and a central axis of the rotating member 25 of the first driving structure is perpendicular to an axis of the output shaft 4.

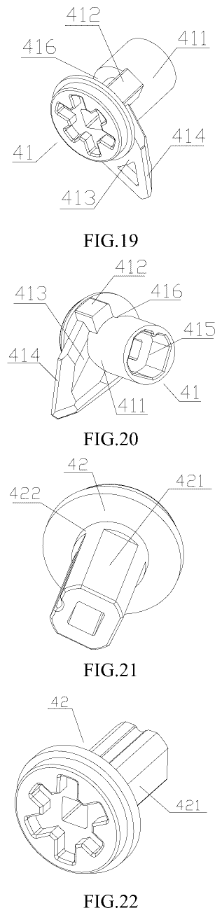

As shown in FIGS. 19 and 20, the first output shaft 41 includes a rotating part and a circular shaft 411, wherein one end of the circular shaft 411 is connected to the middle part of one side of the rotating part, an outer diameter of the rotating part is greater than an outer diameter of the circular shaft 411, and one side of the rotating part away from the circular shaft 411 is used for connection in linkage with the contact mechanism. Preferably, an end surface of the rotating part away from the circular shaft 411 is provided with a concave-convex fit surface that is connected in linkage with the contact mechanism. Further, an annular groove is formed in a side wall of the rotating part away from the circular shaft 411 and used for enabling rotatable support between the rotating part and the housing 1. A groove structure for pluggable fit with the second output shaft 42 is arranged at one end of the circular shaft 411 away from the rotating part, and preferably a square groove is used as the groove structure. A side wall of the first output shaft 41 is provided with the protruding first stopper 412 and the second shifting rod 413, wherein the first stopper 412 is engaged with the first shifting rod 232 of the transmission plate 23, and the second shifting rod 413 is engaged with the third stopper 253 and the fourth stopper 254 of the rotating part 25. In drawings, the first stopper 412 is a square boss arranged on the side wall of the circular shaft 411, immediately adjacent to the rotating part, with a protruding height of the first stopper 412 higher than an edge of the rotating part. The second shifting rod 413 that extends outward is arranged on one side of the first stopper 412, and the second shifting rod 413 may be regarded as an extension plate formed by extending outward from the side wall of the first output shaft 41. The second shifting rod 413 has a plate surface parallel to the end surface of the first output shaft 41. Two inclined planes 414 are arranged at the end of the second shifting rod 413, such that the end of the second shifting rod 413 is high in the middle and low on both sides. As the first output shaft 41 rotates, the two inclined planes 414 are conducive to being engaged with the third stopper 253 and the fourth stopper 254. Furthermore, an annular groove 416 that may avoid the first shifting rod 232 of the transmission plate 23 is formed in one side of the first stopper 412 away from the second shifting rod 413, in order to avoid interfering with the engagement between the first stopper 412 and the first shifting rod 232.

As shown in FIG. 21 and FIG. 22, the second output shaft 42 is integrally formed and includes a rotating part and a square shaft 421. The rotating part of the second output shaft 42 is preferably identical to that of the first output shaft 41. One end of the square shaft 421 is connected to the middle part of one side of the rotating par, with the rotating part having a larger outer diameter than the square shaft 421. A concave-convex fit surface for linkage with the contact mechanism is arranged on one side of the rotating part away from the square shaft 421. Preferably: an annular groove is formed in a side wall of the rotating part away from the square shaft 421 and—is connected to the second driving structure. The other end of the square shaft 421 is in pluggable fit with the square groove 241 of the first output shaft 41. An area of the square shaft 421 immediately adjacent to the rotating part has a circular shaft area 422.

As shown in FIGS. 12-15, the preferred embodiment of the second driving structure includes a fixing member 31 and a locking assembly. The fixing member 31 is integrally of a platy structure with a first avoidance hole 311 in the middle for assembly on the output shaft 4. That is, the first avoidance hole 311 is in rotatable fit with the annular groove of the rotating part in the second output shaft 42. A circular central groove 312 is formed on one side surface of the fixing member 31, providing a rotation space for the locking assembly. A first limiting groove 313 and a second limiting groove 314 are spaced in a circumferential direction of the central groove 312, wherein a central angle on each side of the first limiting groove 313 is greater than that of the second limiting groove 314, meaning an arc length of the first limiting groove 313 is greater than that of the second limiting groove 314.

The locking assembly includes a holding member 33, a sliding member 36 and a locking member 32, all of which are coaxially assembled on the second output shaft 42. As shown in FIGS. 12-16, the holding member 33 is fixedly connected to the second output shaft 42 and is rotatable along with the second output shaft 42. The sliding member 36 is rotatably assembled on the second output shaft 42. The locking member 32 slidably assembled on the sliding member 36 is provided with the locking part 321. The locking member 32 is rotatable around the output shaft 4 via the sliding member 36 and slidable in a radial direction of the output shaft 4 relative to the sliding member 36. That is, the locking member 32 may be in sliding fit with the sliding member 36 in either the first or the second direction. The second energy storage elastic member is connected between the holding member 33 and the locking member 32, and drives the locking part 321 of the locking member 32 to engage in a limiting manner with at least one of the two limiting grooves. A central angle of the locking part 321 is equal to that of the second limiting groove 314. In this way; the first limiting groove 313 has a certain rotational margin when it is engaged with the locking part 321 and may rotate at a preset idle stroke first during the opening process, and the second limiting groove 314 has no rotational margin when it is engaged with the locking part 321.

When the locking part 321 is in clamping fit with one limiting groove, the output shaft 4 rotates and drives the second energy storage elastic member 35 to store energy through the holding member 33. The holding member 33 drives the locking member 32 to slide in the first direction relative to the sliding member 36, such that the locking part 321 is separated and unlocked from one limiting groove. Once unlocked, the second energy storage elastic member 35 releases energy and drives the holding member 33 to drive the output shaft 4 to continue rotating. When the locking part 321 rotates to a position corresponding to the other limiting groove, the locking member 32 is driven to slide in the second direction relative to the sliding member 36 and is locked with the other limiting groove in a limiting manner. Specifically; the second energy storage elastic member 35 includes a rotating part coaxially assembled with the output shaft 4. The rotating part is connected to two elastic arms 351. The holding member 33, the locking member 32 and the sliding member 36 are located between these two elastic arms 351. These two elastic arms 351 of the second energy storage elastic member 35 abut against the locking member 32 and the holding member 33, respectively. During the rotation process of the output shaft 4, the holding member 33 and the locking member 32 are engaged with each other to rotate around the second output shaft 42. During the rotation process of the holding member 33 and the locking member 32 in mutual engagement, the two elastic arms 351 abut against the holding member 33 and the locking member 32 at the same time. When the locking member 32 is clamped with one limiting groove, the locking member 32 and the holding member 33 are misaligned, such that the locking member 32 and the holding member 33 abut against two different elastic arms 351, respectively. At this moment, an included angle between the two elastic arms 351 is expanded, and the second energy storage elastic member 35 stores energy. When the output shaft 4 drives the holding member 33 to continues rotating to the first critical position or the second critical position, the holding member 33 drives the locking member 32 to slide out of one of the limiting grooves in the first direction and to be unlocked, and one elastic arm 351 abutting against the locking member 32 is deformed. As the locking member 32 is driven to rotate towards the other limiting groove, the second energy storage elastic member 35 releases energy and drives the holding member 33 to drive the output shaft 4 to rotate. The elastic arm 351, which is abutting against the locking member 32, gradually returns to its original state and drives the locking part 321 to slide in the second direction into the other limiting groove, thereby achieving limiting locking.

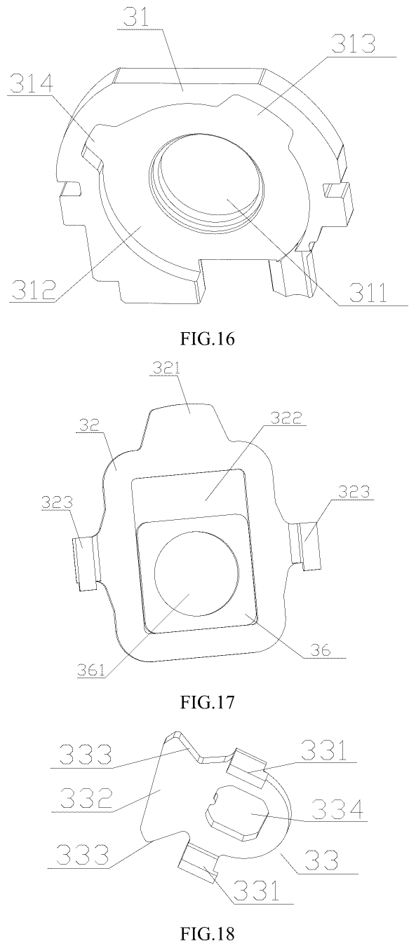

As shown in FIG. 17, the sliding member 36 is integrally of a square platy structure. A circular shaft hole 361 that is rotatably connected to the second output shaft 42 is formed in the middle of the sliding member 36. The circular shaft hole 361 is in rotatable fit with the circular shaft area 422 in the middle of the second output shaft 42. The locking member 32 is integrally of a square platy structure. The locking part 321 is formed by protruding outward from one side edge of the locking member 32. That is, the locking part 321 is located at an edge of the shorter side of the locking member 32, and first clamping arms 323 are respectively arranged on both sides of the locking member 322 adjacent to the locking part 321. That is, first clamping arms 323 are respectively arranged on edges of two longer sides of the locking member 32. A rectangular second avoidance hole 322 is situated in the middle of the locking member 32, allowing the locking member 32 to slide over the outer periphery of the sliding member 36. The second avoidance hole 322 provides a certain sliding space for the locking member 32, such that the locking part 321 of the locking member 32 is able to slide along a direction that is either closer to or further away from the centerline of the sliding member 36, which corresponds to the central axis of the output shaft 4. A direction of the locking part 321 close to the sliding member 36 is the first direction, and a direction of the locking part 321 away from the sliding member 36 is the second direction. When the locking member 32 and the sliding member 36 are jointly assembled on the output shaft 4, a central axis direction of the locking part 321 close to the output shaft 4 is the first direction, and a central axis direction of the locking part 321 away from the output shaft 4 is the second direction.

As shown in FIGS. 12-15, and 18, the holding member 33 is integrally of a platy structure, and a connecting shaft hole 334 connected to the second output shaft 42 is formed in the middle of the holding member 33. As shown in the drawings, the connecting shaft hole 334 is a square hole, and a second clamping arm 331 corresponding to the first clamping arm 323 is arranged on either opposite side of the holding member 33. In this embodiment, the first clamping arm 323 is formed by bending and extending the side edges of the locking member 32 parallel to the axis of the second output shaft 42, and the second clamping arm 331 is formed by bending and extending the side edges of the clamping member 33 parallel to the axis of the second output shaft 42. As shown in the drawings, the two second clamping arms 331 are located between the two first clamping arms 323, and the first clamping arm 323 and the second clamping arm 331 located on the same side may be engaged with the same elastic arm 351. A protruding part 332 that protrudes outward is arranged on the other side of the holding member 33, and the edges of both opposite sides of the protruding part 332 are respectively used as engagement parts 333. In FIG. 18, the engagement part 333 is depicted as an inclined plane, which maximizes the width of the protruding part 332 on the side furthest from the connecting shaft hole 334, and one side of the protruding part 332 close to the connecting shaft hole 334 is located between the two first clamping arms 323. With the holding member 33 that rotates along with the second output shaft 42, the engagement part 333 abuts against the intermediately adjacent first clamping arm 323, and the locking member is pushed to slide and unlock in the first direction.

As shown in FIGS. 12-15, the second energy storage elastic member 35 is sleeved over a copper sleeve 34. The copper sleeve 34, the holding member 33, the locking member 32 and the fixing member 31 are sequentially sleeved onto the second output shaft 42. The holding member 33 is pressed by the copper sleeve 34. A torsion spring is used as the second energy storage elastic member 35, with its central portion preferably serving as a rotating component sleeved over the copper sleeve 34. Two elastic arms 351 of the torsion spring extend toward two opposite directions respectively. Each elastic arm 351 may abut against the first clamping arm 323 and the second clamping arm 331 on the same side. During the rotation process of the second output shaft 42, the holding member 33 rotates with the second output shaft 42 and the locking part 321 of the locking member 32 is locked in a limiting manner. The locking member 32 and the holding member 33 are misaligned, such that the first clamping arm 323 and the second clamping arm 331 located on the same side are misaligned, wherein one of the elastic arms 351 abuts against the first clamping arm 323, and the other elastic arm 351 abuts against the other second clamping arm 331. At this moment, the second energy storage elastic member 35 stores energy. After the locking part 321 of the locking member 32 slides out of one of the limiting grooves and is unlocked, and the second energy storage elastic member 35 releases energy until the locking part 321 of the locking member 32 slides into the other limiting groove.

A specific engagement process of this embodiment is as follows:

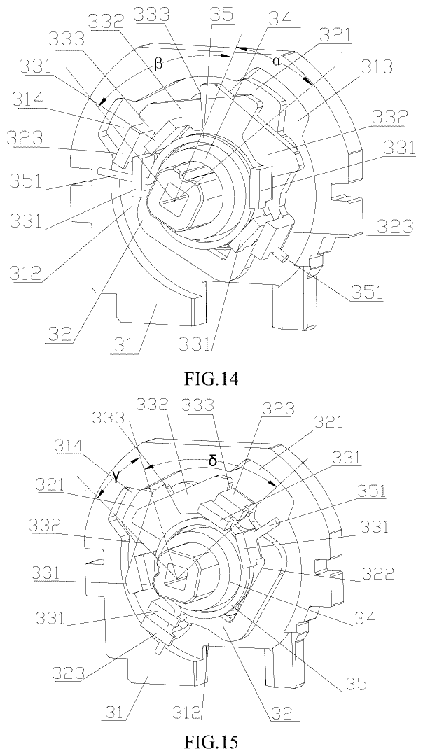

During an opening process, the operating shaft 21 rotates and drives the first transmission shaft 22 to rotate, and a second gear 222 of the first transmission shaft 22 is meshed with a plurality of teeth 231 of the transmission plate 23, such that the transmission plate 23 moves in a horizontal direction as shown in FIG. 2, from a transmission plate closing position of the transmission plate 23 to a transmission plate opening position. Meanwhile the first transmission shaft 22 drives the second transmission shaft 24 to rotate synchronously. The third shifting rod 242 of the second transmission shaft 24 abuts against the second stopper 252 of the rotating member 25 to drive the rotating member 25 to rotate until the rotating member 25 just passes a balanced position of a pair of first energy storage elastic members 26, such that the rotating member 25 rotates rapidly under the energy release of the pair of first energy storage elastic members 26, causing the primary energy storage mechanism 2 to rotate to a first energy release position. Meanwhile, the rotating member 25 rotates rapidly; the fourth stopper 254 abuts against the second shifting rod 413 to drive the first output shaft 41 and the second output shaft 42 to rotate synchronously from the closing position to the first critical position: after the first output shaft 41 and the second output shaft 42 synchronously rotate at a first rotation angle α (see FIG. 14), the engagement part 333 of the holding member 33 presses again the first clamping arm 323 of its adjacent locking member 32, such that the locking member 32 rotates around a circle center of the first avoidance hole 311 (i.e., a central axis of the second output shaft 42) in a central groove 312 of the fixing member 31 until the locking part 321 of the locking member 32 has no rotational margin with the first limiting groove 313. During this period, the second energy storage elastic member 35 does not store energy: When the locking part 321 is clamped with the first limiting groove 313, the second clamping arm 331 of the holding member 33 continues rotating along with the second output shaft 42, such that the second energy storage elastic member 35 stores energy. The second clamping arm 331 on one side of the holding member 33 pushes one elastic arm 351 (the elastic arm 351 on the left side and the second clamping arm 331 on the left side in FIG. 14), and meanwhile, the engagement part 333 on one side of the holding member 33 presses one of the first clamping arms 323 of the locking member 32 (the engagement part 333 on the left side in FIG. 14 presses the first clamping arm 323 on the left side), such that the locking member 32 begins to slide in the first direction, and the other first clamping arm 323 of the locking member 32 abuts against the other elastic arm 351 (the first clamping arm 323 on the right side abuts against the elastic arm 351 on the right side in FIG. 14). At this moment, an annular gap between the two elastic arms 351 increases the energy storage. Simultaneously, as the locking member 32 slides in the first direction, the locking part 321 is separated from the first limiting groove 313, and the elastic arm 351 pressed by the first clamping arm 323 undergoes an elastic deformation; and subsequently, when the primary energy storage mechanism 2 rotates to the first energy release position (i.e., an energy release completion position of the first energy storage elastic member 26 during the opening process), the first energy storage elastic member 26 drives the output shaft 4 to the first critical position, and the second energy storage elastic member 35 completes energy storage and has begun to release energy. The other elastic arm 351 of the second energy storage elastic member 35 abuts against the other first clamping arm 323 (the elastic arm 351 located on the right side and the first clamping arm 323 located on the right side) of the locking member 32, such that the locking member 32 rotates rapidly towards the second limiting groove 314 under the energy release of the second energy storage elastic member 35. During this process, the other elastic arm 351 gradually resets, and the locking member 32 slides in the second direction by pushing the other first clamping arm 323 (the elastic arm 351 on the right side in FIG. 14 pushes the first clamping arm 323 on the right side) until the locking part 321 and the second limiting groove 314 are locked in a limiting manner At this moment, the first output shaft 41 and the second output shaft 42 rotate synchronously through a certain angle. i.e., to a second rotation angle from the output shaft 4 from the first critical position to the opening position, and the second rotation angle is represented by β in FIG. 14. At this time, the first stopper 412 of the first output shaft 41 abuts against the first shifting rod 232 of the transmission plate 23, and the output shaft 4 rotates to the opening position, achieving two rotations of the output shaft, which are then transmitted to the contact mechanism to increase an opening distance.

During the closing process, the operating shaft 21 rotates to drive the first transmission shaft 22 to rotate. The second gear 222 of the first transmission shaft 22 is meshed with a plurality of teeth 231 of the transmission plate 23 to make the transmission plate 23 move, such that the transmission plate 23 moves from the transmission plate opening position to the transmission plate closing position. The first shifting rod 232 of the transmission plate 23 moves against the first stopper 412 of the first output shaft 41, such that the first output shaft 41 drives the second output shaft 42 to rotate through a certain angle, that is, the output shaft 4 rotates from the opening position to the second critical position, and a rotation angle of the output shaft 4 is a third rotation angle at this moment. In FIG. 15, the third rotation angle is represented by γ. The second energy storage elastic member 35 stores energy, and meanwhile, the third shifting rod 242 of the second transmission shaft 24 drives the rotating member 25 to rotate against the third stopper 253 of the rotating member 25, until the rotating member 25 drives the first energy storage elastic member 26 to rotate over the balanced position of the pair of first energy storage elastic members 26. After the first energy storage elastic member 26 rotates over the balanced position and releases energy; the rotating member 25 rotates rapidly driven by the energy release of the pair of first energy storage elastic members 26, such that the third stopper 253 abuts against the second shifting rod 413 of the first output shaft 41 and also drives the first output shaft 41 and the second output shaft 42 to rotate to the second critical position.

As the output shaft 4 rotates from the closing position to the second critical position, the locking part 321 of the locking member 32, which has no rotational margin with the second limiting groove 314, causes the first output shaft 41 and the second output shaft 42 to drive the holding member 33 to rotate synchronously. The rotation of the holding member 33 overcomes the elastic force of the second energy storage elastic member 35, storing energy in the second energy storage elastic member 35. That is, when the locking part 321 is in clamping fit with the second limiting groove 314, the second clamping arm 331 of the holding member 33 is misaligned with the first clamping arm 323 of the locking member 32. The first clamping arm 323 on one side of the locking member 32 abuts against one elastic arm 351 of the second energy storage elastic member 35 (the first clamping arm 323 on the left side abuts against the elastic arm 351 on the left side in FIG. 15); the other elastic arm 351 stores energy by rotating and pressing with the second clamping arm 331 located on the other side (the elastic arm 351 on the right side and the second clamping arm 331 on the right side in FIG. 15). Concurrently: an engagement part 333 of the holding member 33 presses against the first clamping arm 323 (i.e., the engagement part 333 on the right side and the first clamping arm 323 on the right side in FIG. 15) of its adjacent locking member 32, such that the locking member 32 is in sliding fit with the sliding member 36 in the first direction, i.e., slides close to a central axis direction of the second output shaft 42, till the locking part 321 is separated and unlocked from the second limiting groove 314; and
after the output shaft 4 has rotated to the second critical position, the second energy storage elastic member 35 releases energy. The first energy storage elastic member 26 continues releasing energy, such that the first output shaft 41 and the second output shaft 42 continue rotating towards the closing direction. With the energy release of the second energy storage elastic member 35, one elastic arm 351 of the second energy storage elastic member 35 abuts against the first clamping arm 323 of the locking member 32 (that is, the elastic arm 351 on the left side abuts against the first clamping arm 323 on the left side in FIG. 15), such that the locking member 32 rotates rapidly under the energy release of the second energy storage elastic member 35. Meanwhile, the elastic arm 351 gradually resets and pushes the first clamping arm 323 to make the locking member 32 slide in the second direction, till the locking part 321 is in limiting fit with the first limiting groove 313 to achieve locking. At this moment, the first output shaft 41 and the second output shaft 42 have been driven by the primary energy storage mechanism 2 to the closed position, the primary energy storage mechanism 2 is located at a second energy release position (i.e., an energy release completion position of the first energy storage elastic member 26 during the closing process). A rotation angle of the output shaft 4 rotating from the second critical position to the closing position is a fourth rotation angle, and the fourth rotation angle is represented by δ in FIG. 15.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An operating mechanism, comprising a primary energy storage mechanism and an output shaft, and also a secondary energy storage mechanism wherein the secondary energy storage mechanism comprises a second driving structure and a second energy storage elastic member which are coaxially assembled on the output shaft; the second driving structure comprises a fixing member and a locking assembly; the fixing member is provided with two limiting grooves; the primary energy storage mechanism releases energy during an opening process to drive the output shaft to rotate and stores energy for the second energy storage elastic member; after the output shaft drives a locking part of the locking assembly to slide out from one of the limiting grooves and to be unlocked, the second energy storage elastic member releases energy and drives the locking assembly to drive the output shaft to continue rotating to an opening position, and the locking part is driven to slide into the other limiting groove to be locked in a limiting manner.

2. The operating mechanism according to claim 1, wherein the two limiting grooves are a first limiting groove and a second limiting groove, respectively; during an opening process, the locking part first rotates through a preset idle stroke within the first limiting groove along with the output shaft; and after the locking part has no rotational margin within the first limiting groove, the second energy storage elastic member begins to store energy.

3. The operating mechanism according to claim 2, wherein a central angle of the first limiting groove is greater than a central angle of the second limiting groove, and a central angle of the second limiting groove is equal to a central angle of the locking part; during an opening process, the locking part is unlocked from the first limiting groove first, and then locked with the second limiting groove; and during a closing process, the locking part is unlocked from the second limiting groove first, and then locked with the first limiting groove.

4. The operating mechanism according to claim 1, wherein the locking assembly comprises a holding member, a sliding member and a locking member; the holding member; is fixedly connected to the output shaft, and the sliding member; is rotatably assembled on the output shaft and is slidably assembled with the locking member; the locking member is provided with the locking part, and the locking member is rotatable around the output shaft through the sliding member and slidable in a radial direction of the output shaft relative to the sliding member; the second energy storage elastic member is connected between the holding member; and the locking member; and the locking part of the locking member is driven to be locked with at least one of the two limiting grooves in a limiting manner.

5. The operating mechanism according to claim 4, wherein when the locking part is in clamping fit with one of the limiting grooves, the output shaft rotates and drives the second energy storage elastic member to store energy through the holding member; the holding member drives the locking member to slide in a first direction relative to the sliding member, such that the locking part is separated and unlocked from one limiting groove; the unlocked second energy storage elastic member releases energy and drives the holding member to drive the output shaft to continue rotating; and when the locking part rotates to a position corresponding to the other limiting groove, the locking member is driven to slide in a second direction relative to the sliding member and is locked with the other limiting groove in a limiting manner.

6. The operating mechanism according to claim 4, wherein a first avoidance hole for assembling the output shaft is located in the middle of the fixing member, a central groove for the locking assembly to rotate is located on a surface on one side of the fixing member, and the two limiting grooves are spaced in a circumferential direction of the central groove.

7. The operating mechanism according to claim 5, wherein a circular shaft hole that is formed in the middle of the sliding member for rotatably connecting to the output shaft, and an edge on one side of the locking member protrudes outward to form the locking part; a first clamping arms are respectively arranged on both sides of the locking member adjacent to the locking part; a second avoidance hole is formed in the middle of the locking member; the locking member slidably sleeves the periphery of the sliding member through the second avoidance hole; a direction of the locking part close to the sliding member is defined as the first direction; and a direction of the locking part away from the sliding member is defined as the second direction; and
a connecting shaft hole that is formed in the middle of the holding member for connection to the output shaft; a second clamping arm which corresponds to the first clamping arms are respectively arranged on both opposite sides of the holding member, and a protrusion that protrudes outward is arranged on the other side of the holding member; the edges on both opposite sides of the protrusion are respectively used as engagement parts, for abutting against the corresponding first clamping arms; and the locking member is pushed to be slidably unlocked in the first direction.

8. The operating mechanism according to claim 7, wherein the second energy storage elastic member comprises a rotating part coaxially assembled with the output shaft; the rotating part is connected to two elastic arms; the first clamping arm and the second clamping arm located on the same side abut against the same elastic arm; when the second energy storage elastic member stores energy, the holding member and the sliding member are misaligned, with one elastic arm abutting against one of the first clamping arms, and the other elastic arm abutting against the second clamping arm on the other side; and
when the locking part moves in the first direction and is separated and unlocked from the limiting groove, the first clamping arm presses against the elastic arm to generate an elastic deformation; and when the second elastic energy storage member releases energy to drive the locking member to rotate, the elastic arm releases energy to push the first clamping arm, such that the locking part is locked with the other limiting groove in the second direction in a limiting manner.

9. The operating mechanism according to claim 1, wherein the primary energy storage mechanism comprises a first driving structure and at least one first energy storage elastic member; the first driving structure comprises an operating shaft-Hand a rotating member that are connected in linkage sequentially, wherein the rotating member is in linkage fit with the output shaft; the first energy storage elastic member is engaged with the rotating member; the operating shaft drives the rotating member to rotate, such that the first energy storage elastic member rotates to a balanced position to store energy; and the first energy storage elastic member releases energy after crossing the balanced position and drives the rotating member to rotate, such that the rotating member drives the output shaft to rotate.

10. The operating mechanism according to claim 9, wherein during an opening process, the first energy storage elastic member releases energy and drives the output shaft to rotate from a closing position to a first critical position through the rotating member; and the output shaft rotates and drives the second energy storage elastic member to release energy after energy storage, driving the output shaft to continue rotating to an opening position.

11. The operating mechanism according to claim 9, wherein the first driving structure further comprises an operating shaft, a transmission assembly and a rotating member; the operating shaft drives the rotating member rotate through the transmission assembly, and the transmission assembly and the rotating member are in linkage with the output shaft respectively; during an opening process, the operating shaft drives the rotating member to rotate through the transmission assembly, the rotating member rotates and drives the first energy storage elastic member to release energy after crossing a balanced position, the first energy storage elastic member releases energy and drives the output shaft to rotate to the first critical position through the rotating member, and the output shaft rotates and drives the second energy storage elastic member to release energy after energy storage, driving the output shaft to continue rotating to an opening position; and during a closing process, the operating shaft drives the rotating member to rotate through the transmission assembly, such that the first energy storage elastic member rotates to the balanced position to store energy and to release energy after crossing the balanced position, and meanwhile, the transmission assembly also drives the output shaft to rotate, such that the second energy storage elastic member releases energy after energy storage, and the first energy storage elastic member releases energy and drives the output shaft to rotate to a closing position through the rotating member.

12. The operating mechanism according to claim 11, wherein the transmission assembly comprises a transmission shaft and a transmission plate; the transmission shaft is rotatably arranged; the transmission plate is arranged in linear motion; the operating shaft drives the rotating member to rotate through the transmission shaft; the operating shaft drives the transmission plate to move linearly between a transmission plate opening position and a transmission plate closing position; and during a closing process, the operating shaft drives the transmission plate to move towards the transmission plate closing position, and drives the output shaft to rotate through the transmission plate.

13. The operating mechanism according to claim 12, wherein the transmission shaft comprises a first transmission shaft and a second transmission shaft; the first transmission shaft is fixedly connected to or in transmission fit with the second transmission shaft; the first transmission shaft is in linkage with the operating shaft and the transmission plate; respectively; the second transmission shaft is in linkage with the rotating member; the transmission plate and the rotating member, are in linkage fit with the output shaft respectively; the operating shaft is provided with a first gear surrounding a side wall; a gear part that is in meshed connection with the first gear is arranged on one side of the first transmission shaft facing the operating shaft; a second gear surrounding the side wall of the first transmission shaft is arranged in the middle of the first transmission shaft; the second gear, is in meshed connection with teeth of the transmission plate; and the transmission plate is provided with a first shifting rod, and the second transmission shaft is provided with a third shifting rod which is used for driving the rotating member to rotate;
a side wall of the output shaft is provided with a protruding first stopper and a second shifting rod, and the first stopper is engaged with the first shifting rod of the transmission plate; and
one end of the rotating member Sais rotatably installed; spring clamping grooves are formed on both opposite sides of the rotating member respectively; a second stopper, a third stopper block and a fourth stopper are spaced annularly in sequence at the other end of the rotating member in a protruding manner; the second stopper and the third stopper are used for abutting against the third shifting rod; and the third stopper and the fourth stopper are used for abutting against the second shifting rod.

14. The operating mechanism according to claim 9, wherein a central axis of the rotating member of the first driving structure is perpendicular to an axis of the output shaft.

15. An isolating switch, comprising a shell within which at least one conductive system and the operating mechanism according to claim 1 are assembled, wherein a contact mechanism of the conductive system is connected in linkage with an output shaft of the operating mechanism.
